(19) United States
(12) Patent Application Publication
(10) Pub. No.: US 2008/0157494 A1
(43) Pub. Date: Jul. 3, 2008

(54) Cart that is Assembled Solidly and Stably

(76) Inventor: Ming-Hsiao Nieh, Taichung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/847,672

(22) Filed: Aug. 30, 2007

(30) Foreign Application Priority Data
Dec. 28, 2006 (DE) 202006019554.8

(51) Int. Cl. B62B 3/02

(52) U.S. Cl. 280/47.34; 312/249.11

(57) ABSTRACT

A cart includes a plurality of placement boards, a plurality of connecting posts mounted between the placement boards, a plurality of side plates mounted between the placement boards and the connecting posts, two handles mounted on an uppermost placement board, and a plurality of castors mounted on a lowermost placement board. Thus, each of the side plates is located between any two of the placement boards and between any two of the connecting posts to reinforce the combination strength of the placement boards and the connecting posts so as to reinforce the structural strength of the cart. In addition, the cart is assembled solidly and stably so that the cart is not loosened or detached easily after assembly to provide a safety to a user.

### BACKGROUND OF THE INVENTION

1. Field of the Invention

The present invention relates to a cart and, more particularly, to a serving cart for placing dishes or a tool cart for placing hand tools.

2. Description of the Related Art

A conventional cart in accordance with the prior art shown in FIG. 10 comprises a plurality of transverse placement boards 70, a plurality of upright connecting posts 80 mounted between the placement boards 70, two handles 73 mounted on an uppermost one of the placement boards 70, and a plurality of castors (not shown) mounted on a lowermost one of the placement boards 70. Each of the placement boards 70 has a periphery provided with a plurality of protruding stop flanges 71 which extend upward and downward from each of the placement boards 70. Each of the placement boards 70 has a plurality of corners each formed with a slot 72 to allow insertion of a respective connecting post 80. However, each of the connecting posts 80 is mounted in the respective slot 72 of each of the placement boards 70 in a loosely fit manner, so that the connecting posts 80 are easily detached from the placement boards 70 when the placement boards 70 are pulled by the handles 73 to upset the articles placed on the placement boards 70, thereby causing danger to the user.

### BRIEF SUMMARY OF THE INVENTION

In accordance with the present invention, there is provided a cart, comprising a plurality of transverse placement boards, a plurality of upright connecting posts mounted between any two of the placement boards, and a plurality of side plates mounted between any two of the placement boards and located between any two of the connecting posts.

The primary objective of the present invention is to provide a cart that is assembled solidly and stably so that the cart is not loosened or detached easily after assembly to provide a safety to a user.

Another objective of the present invention is to provide a cart, wherein the insertion edge of each of the side plates is inserted into the insertion slot of the support flange of the respective connecting post, and the clamping pieces of each of the side plates are clamped on the stop flanges of each of the placement boards, so that each of the side plates is located between any two of the placement boards and between any two of the connecting posts to reinforce the combination strength of the placement boards and the connecting posts so as to reinforce the structural strength of the cart.

A further objective of the present invention is to provide a cart, wherein when the connecting posts are mounted between the placement boards, the insert of each of the placement boards is inserted into the insertion hole of the respective connecting post, and each of the limit pieces of each of the placement boards is inserted into the respective limit groove of the respective connecting post by a tapering engagement, so that the connecting posts are combined with the placement boards tightly and closely.

A further objective of the present invention is to provide a cart, wherein when the handles are mounted on the uppermost one of the placement boards, the mounting groove of each of the handles is mounted on the insert of the uppermost one of the placement boards, and each of the limit slots of each of the handles is mounted on the limit pieces of the uppermost one of the placement boards by a tapering engagement, so that the handles are combined with the uppermost one of the placement boards tightly and closely.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a cart in accordance with the preferred embodiment of the present invention.

FIG. 2 is a partially exploded perspective view of the cart as shown in FIG. 1.

FIG. 3 is a partially exploded perspective enlarged view of the cart as shown in FIG. 1.

FIG. 4 is a cross-sectional view of the cart taken along line 4-4 as shown in FIG. 1.

FIG. 5 is a cross-sectional view of the cart taken along line 5-5 as shown in FIG. 1.

FIG. 6 is a perspective view of a cart in accordance with another preferred embodiment of the present invention.

FIG. 7 is a partially exploded perspective view of the cart as shown in FIG. 6.

FIG. 8 is a schematic operational view of the cart as shown in FIG. 7.

FIG. 9 is a partially exploded perspective view of a cart in accordance with another preferred embodiment of the present invention.

FIG. 10 is an exploded perspective view of a conventional cart in accordance with the prior art.

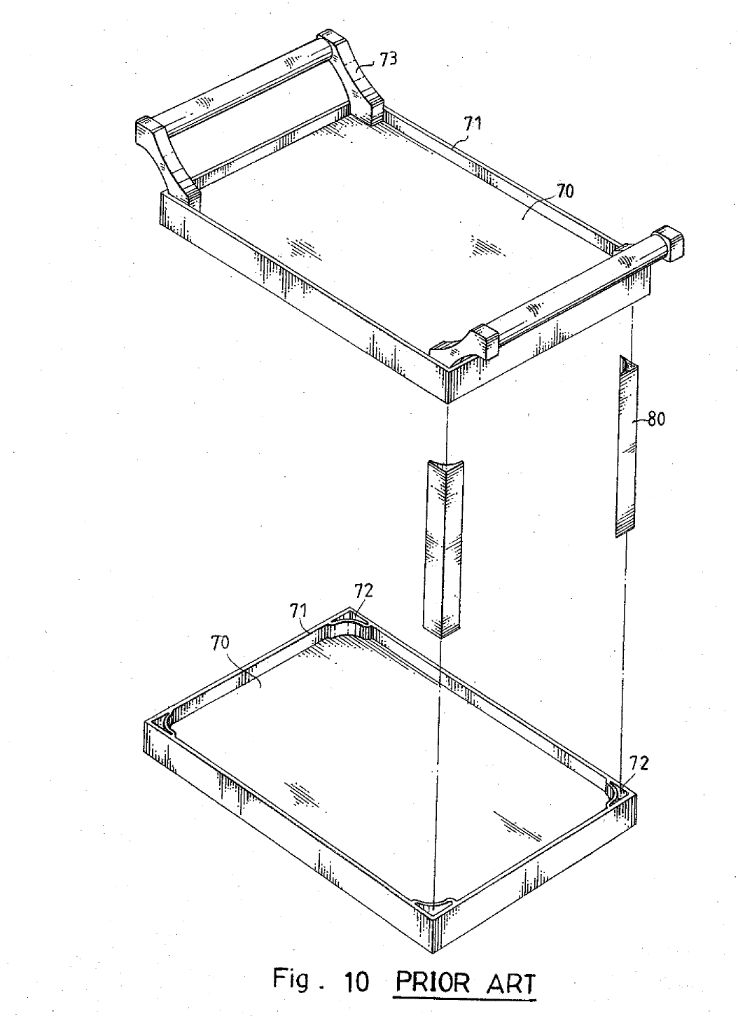

### DETAILED DESCRIPTION OF THE INVENTION

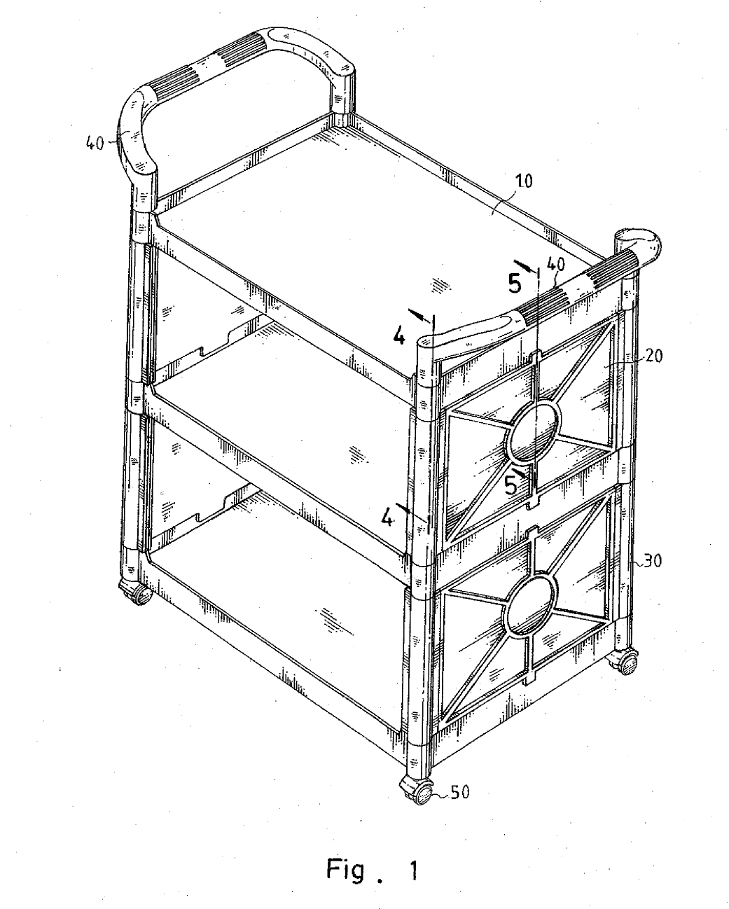

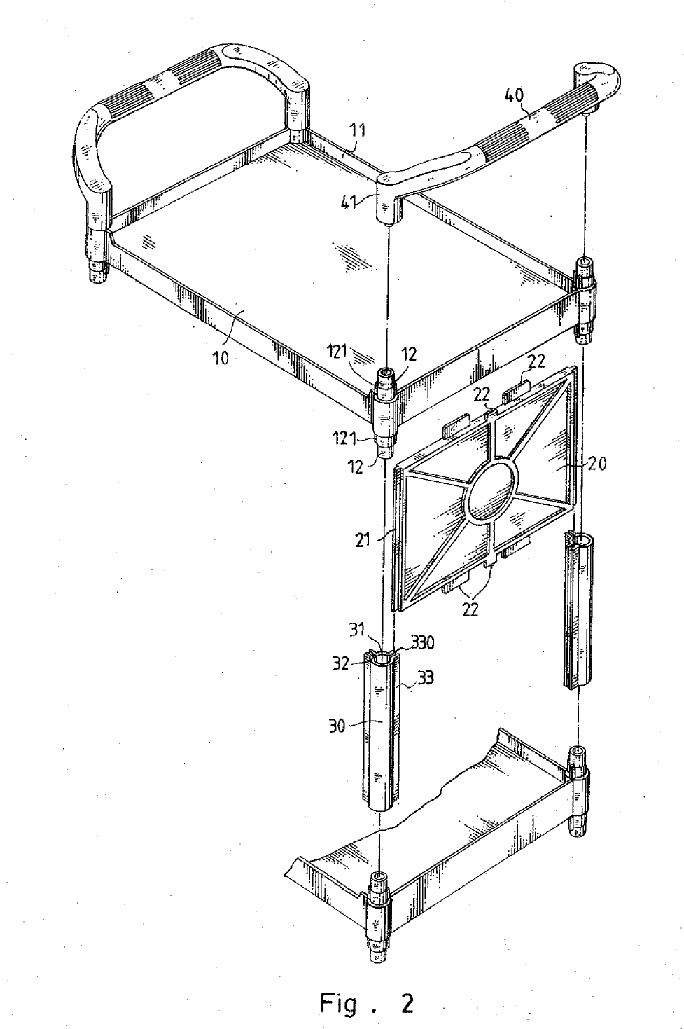

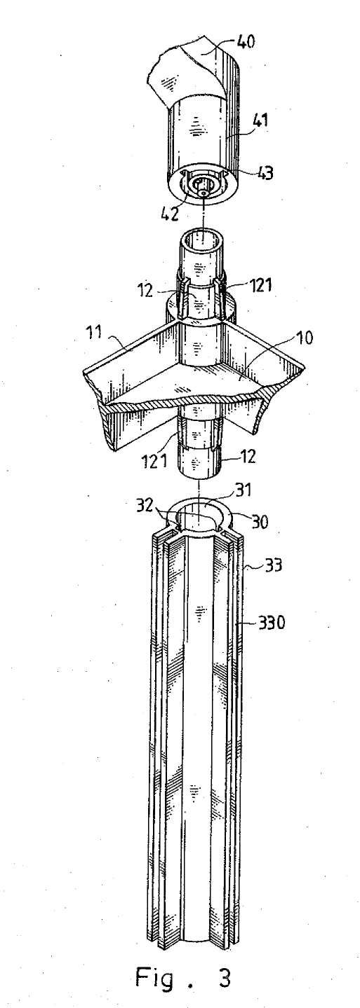

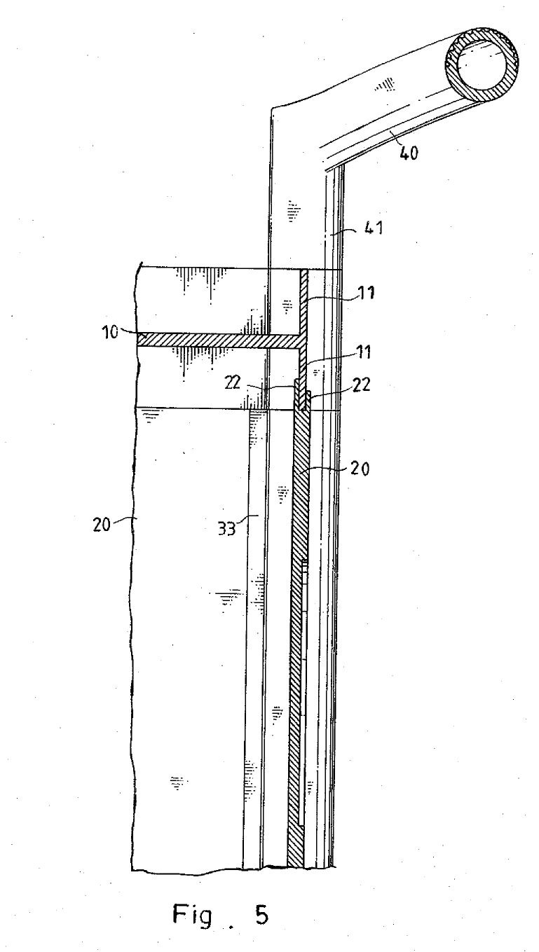

Referring to the drawings and initially to FIGS. 1-5, a cart in accordance with the preferred embodiment of the present invention comprises a plurality of transverse placement boards 10, a plurality of upright connecting posts 30 mounted between any two of the placement boards 10, a plurality of side plates 20 mounted between any two of the placement boards 10 and located between any two of the connecting posts 30, two handles 40 mounted on an uppermost one of the placement boards 10, and a plurality of castors 50 mounted on a lowermost one of the placement boards 10.

Each of the connecting posts 30 has a tubular shape and has an inner wall formed with an insertion hole 31 which extends axially through a whole length of each of the connecting posts 30. The insertion hole 31 of each of the connecting posts 30 has a peripheral wall formed with two axially extending limit grooves 32. Each of the limit grooves 32 of each of the connecting posts 30 has a tapered cross-sectional profile. Each of the connecting posts 30 has an outer wall formed with at least one protruding support flange 33 which has an inside formed with an elongated axially extending insertion slot 330.

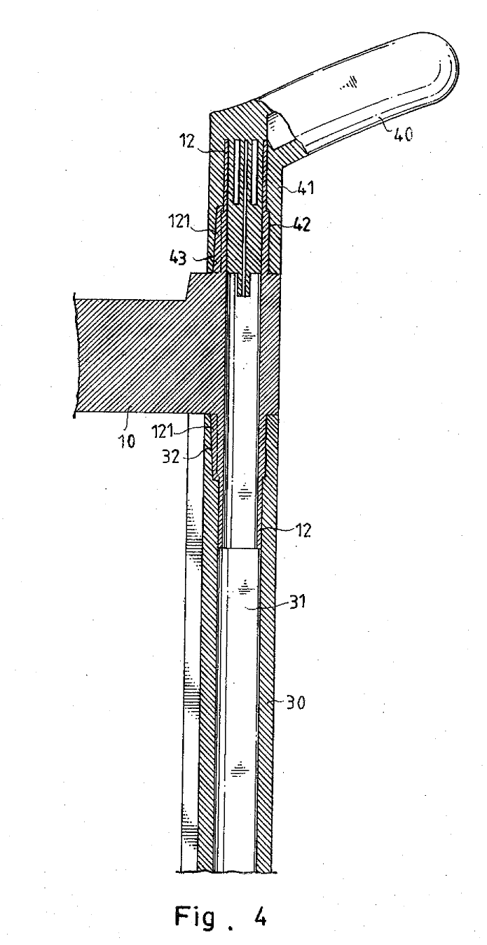

Each of the placement boards 10 has a plurality of corners each provided with a protruding insert 12 inserted into the insertion hole 31 of the respective connecting post 30. The insert 12 of each of the placement boards 10 has a tubular shape and extends upward and downward from each of the placement boards 10. The insert 12 of each of the placement boards 10 has an upper end and a lower end each provided with two protruding limit pieces 121 each inserted into the respective limit groove 32 of the respective connecting post 30. Each of the limit pieces 121 of each of the placement boards 10 has a tapered cross-sectional profile and has a size greater than that of each of the limit grooves 32 of each of the connecting posts 30. Each of the limit pieces 121 of the upper end of the insert 12 of each of the placement boards 10 has a thickness reduced gradually in an upward direction, and each of the limit pieces 121 of the lower end of the insert 12 of each of the placement boards 10 has a thickness reduced gradually in a downward direction as shown in FIG. 4. Each of the placement boards 10 has a periphery provided with a plurality of protruding stop flanges 11 which extend upward and downward from each of the placement boards 10.

Each of the side plates 20 is a sheet plate. Each of the side plates 20 has two opposite sides each provided with a reduced insertion edge 21 inserted into the insertion slot 330 of the support flange 33 of the respective connecting post 30. Each of the side plates 20 has an upper end and a lower end each provided with a plurality of recessed clamping pieces 22 clamped on the stop flanges 11 of each of the placement boards 10.

Each of the handles 40 has two ends each provided with a downward extending mounting stud 41 which has an inside formed with an annular mounting groove 42 mounted on the insert 12 of the uppermost one of the placement boards 10. The mounting groove 42 of each of the handles 40 has a peripheral wall formed with two axially extending limit slots 43 mounted on the limit pieces 121 of the uppermost one of the placement boards 10. Each of the limit slots 43 of each of the handles 40 has a tapered cross-sectional profile and has a size smaller than that of each of the limit pieces 121 of each of the placement boards 10.

Each of the castors 50 is mounted on the insert 12 of the lowermost one of the placement boards 10.

In assembly, when the connecting posts 30 are mounted between the placement boards 10, the insert 12 of each of the placement boards 10 is inserted into the insertion hole 31 of the respective connecting post 30, and each of the limit pieces 121 of each of the placement boards 10 is inserted into the respective limit groove 32 of the respective connecting post 30 by a tapering engagement, so that the connecting posts 30 are combined with the placement boards 10 tightly and closely. In addition, when the handles 40 are mounted on the uppermost one of the placement boards 10, the mounting groove 42 of each of the handles 40 is mounted on the insert 12 of the uppermost one of the placement boards 10, and each of the limit slots 43 of each of the handles 40 is mounted on the limit pieces 121 of the uppermost one of the placement boards 10 by a tapering engagement, so that the handles 40 are combined with the uppermost one of the placement boards 10 tightly and closely. In addition, the insertion edge 21 of each of the side plates 20 is inserted into the insertion slot 330 of the support flange 33 of the respective connecting post 30, and the clamping pieces 22 of each of the side plates 20 are clamped on the stop flanges 11 of each of the placement boards 10, so that each of the side plates 20 is located between any two of the placement boards 10 and between any two of the connecting posts 30 to reinforce the structural strength of the cart.

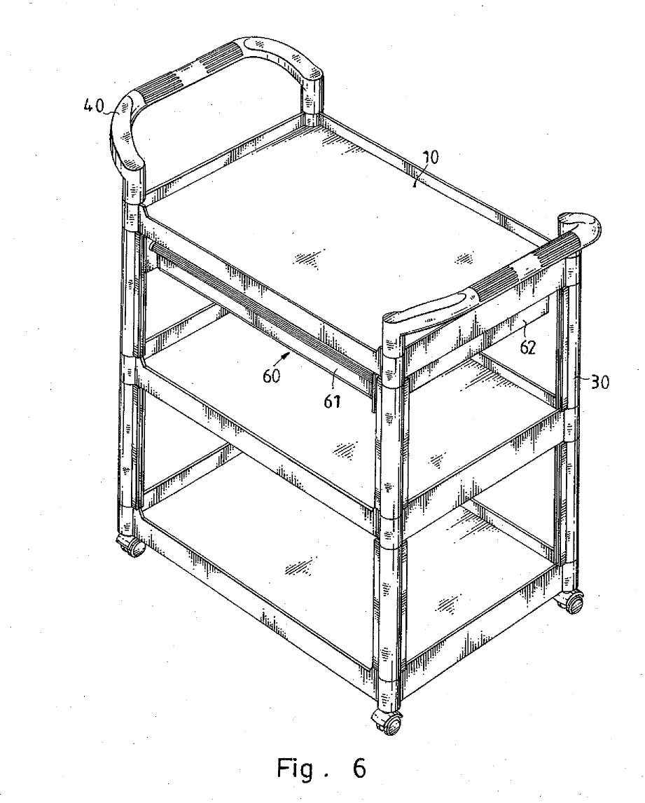

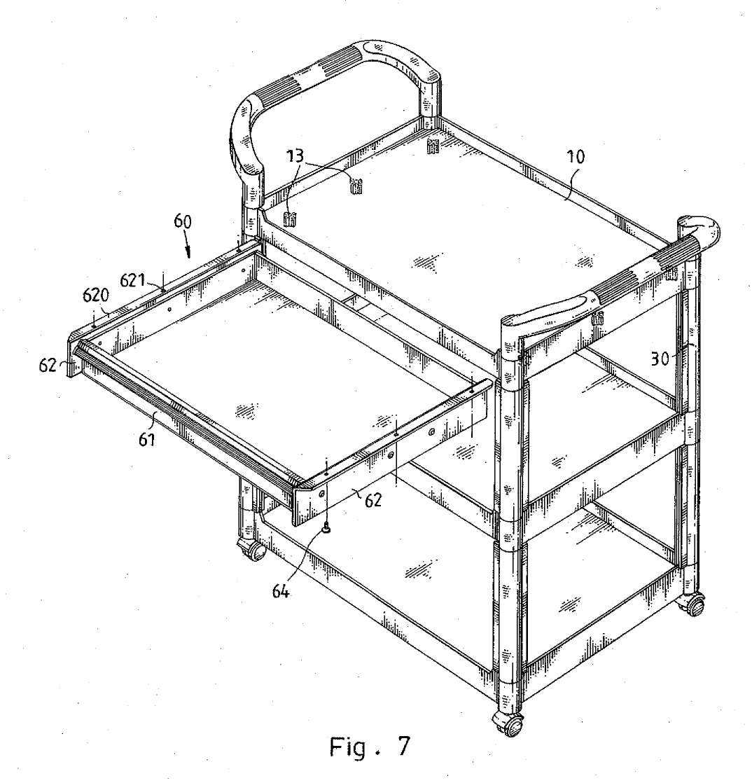

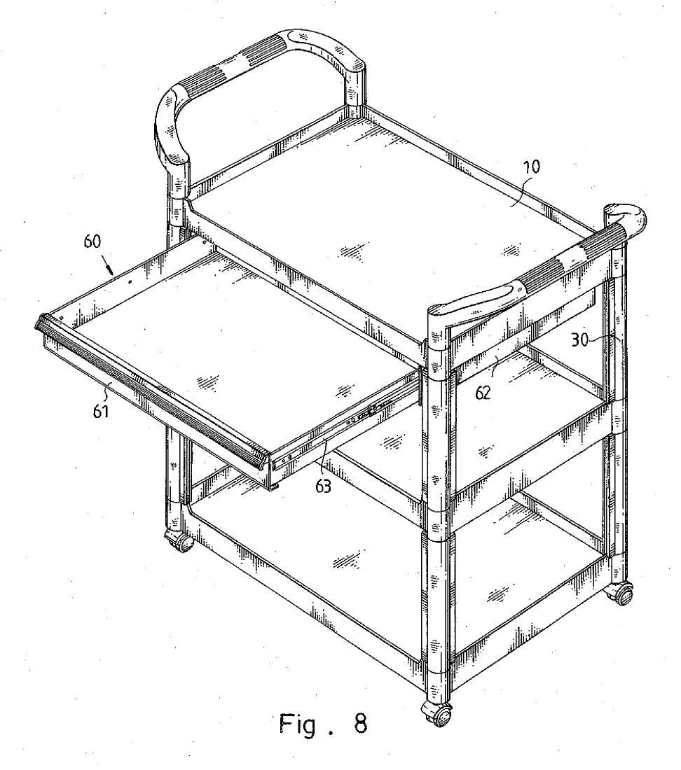

Referring to FIGS. 6-8 with reference to FIGS. 1-5, the cart further comprises at least one drawer unit 60 movably mounted on one of the placement boards 10. Each of the placement boards 10 has a bottom provided with a plurality of fixing seats 13. The drawer unit 60 includes two opposite upright support plates 62 each secured on one of the placement boards 10, and a drawer 61 movably mounted between the support plates 62. The drawer 61 of the drawer unit 60 has two opposite sides each provided with a transverse slide track 63 movably mounted on the respective support plate 62. Each of the support plates 62 of the drawer unit 60 has a top provided with a protruding bent edge 620 having a plurality of through holes 621, and the drawer unit 60 further includes a plurality of locking screws 64 each extended through the respective through hole 621 of the bent edge 620 of each of the support plates 62 and each screwed into the respective fixing seat 13 of the respective placement board 10.

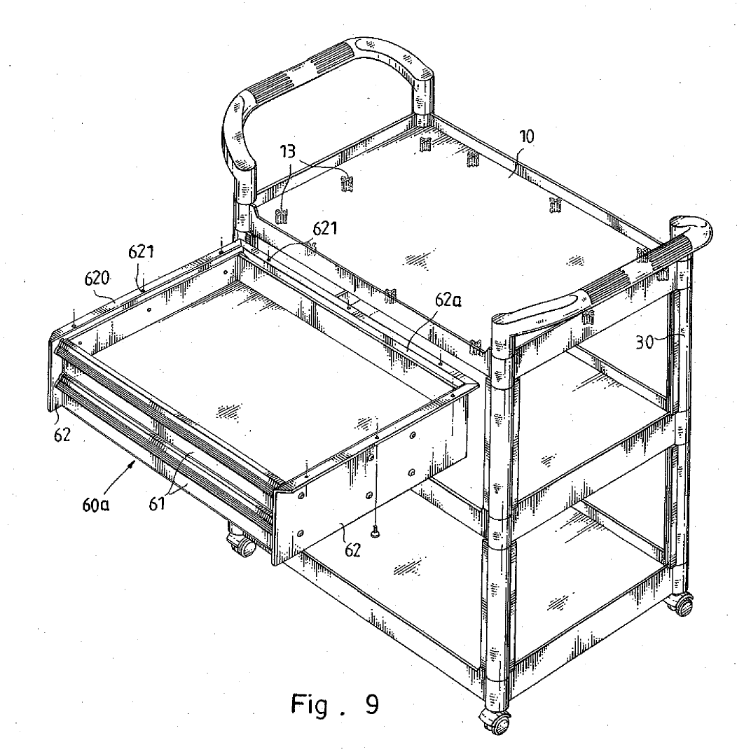

Referring to FIG. 9, the drawer unit 60a further includes a reinforcing piece 62a located between the bent edges 620 of the support plates 62 and secured to the respective placement board 10 to reinforce the structural strength between the support plates 62 and the respective placement board 10.

Accordingly, the insertion edge 21 of each of the side plates 20 is inserted into the insertion slot 330 of the support flange 33 of the respective connecting post 30, and the clamping pieces 22 of each of the side plates 20 are clamped on the stop flanges 11 of each of the placement boards 10, so that each of the side plates 20 is located between any two of the placement boards 10 and between any two of the connecting posts 30 to reinforce the combination strength of the placement boards 10 and the connecting posts 30 so as to reinforce the structural strength of the cart. In addition, when the connecting posts 30 are mounted between the placement boards 10, the insert 12 of each of the placement boards 10 is inserted into the insertion hole 31 of the respective connecting post 30, and each of the limit pieces 121 of each of the placement boards 10 is inserted into the respective limit groove 32 of the respective connecting post 30 by a tapering engagement, so that the connecting posts 30 are combined with the placement boards 10 tightly and closely. Further, when the handles 40 are mounted on the uppermost one of the placement boards 10, the mounting groove 42 of each of the handles 40 is mounted on the insert 12 of the uppermost one of the placement boards 10, and each of the limit slots 43 of each of the handles 40 is mounted on the limit pieces 121 of the uppermost one of the placement boards 10 by a tapering engagement, so that the handles 40 are combined with the uppermost one of the placement boards 10 tightly and closely.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A cart, comprising:
a plurality of transverse placement boards;
a plurality of upright connecting posts mounted between any two of the placement boards;
a plurality of side plates mounted between any two of the placement boards and located between any two of the connecting posts.

2. The cart in accordance with claim 1, wherein
each of the connecting posts has an inner wall formed with an insertion hole;
each of the placement boards has a plurality of corners each provided with a protruding insert inserted into the insertion hole of the respective connecting post.

3. The cart in accordance with claim 2, wherein
the insertion hole of each of the connecting posts has a peripheral wall formed with two axially extending limit grooves;
the insert of each of the placement boards has an upper end and a lower end each provided with two protruding limit pieces each inserted into the respective limit groove of the respective connecting post.

4. The cart in accordance with claim 1, wherein
each of the connecting posts has an outer wall formed with at least one protruding support flange which has an inside formed with an elongated axially extending insertion slot;
each of the side plates has two opposite sides each provided with a reduced insertion edge inserted into the insertion slot of the support flange of the respective connecting post.

5. The cart in accordance with claim 1, wherein
each of the placement boards has a periphery provided with a plurality of protruding stop flanges which extend upward and downward from each of the placement boards;
each of the side plates has an upper end and a lower end each provided with a plurality of recessed clamping pieces clamped on the stop flanges of each of the placement boards.

6. The cart in accordance with claim 3, further comprising two handles mounted on an uppermost one of the placement boards.

7. The cart in accordance with claim 6, wherein each of the handles has two ends each provided with a downward extending mounting stud which has an inside formed with an annular mounting groove mounted on the insert of the uppermost one of the placement boards.

8. The cart in accordance with claim 7, wherein the mounting groove of each of the handles has a peripheral wall formed with two axially extending limit slots mounted on the limit pieces of the uppermost one of the placement boards.

9. The cart in accordance with claim 8, wherein
each of the limit grooves of each of the connecting posts has a tapered cross-sectional profile.
each of the limit pieces of each of the placement boards has a tapered cross-sectional profile;
each of the limit slots of each of the handles has a tapered cross-sectional profile.

10. The cart in accordance with claim 9, wherein
each of the limit pieces of the upper end of the insert of each of the placement boards has a thickness reduced gradually in an upward direction;
each of the limit pieces of the lower end of the insert of each of the placement boards has a thickness reduced gradually in a downward direction.

11. The cart in accordance with claim 8, wherein
each of the limit pieces of each of the placement boards has a size greater than that of each of the limit grooves of each of the connecting posts;
each of the limit slots of each of the handles has a size smaller than that of each of the limit pieces of each of the placement boards.

12. The cart in accordance with claim 1, further comprising at least one drawer unit movably mounted on one of the placement boards.

13. The cart in accordance with claim 12, wherein the drawer unit includes two opposite upright support plates each secured on one of the placement boards, and a drawer movably mounted between the support plates.

14. The cart in accordance with claim 13, wherein the drawer of the drawer unit has two opposite sides each provided with a transverse slide track movably mounted on the respective support plate.

15. The cart in accordance with claim 13, wherein
each of the placement boards has a bottom provided with a plurality of fixing seats;
each of the support plates of the drawer unit has a top provided with a protruding bent edge having a plurality of through holes;
the drawer unit further includes a plurality of locking screws each extended through the respective through hole of the bent edge of each of the support plates and each screwed into the respective fixing seat of the respective placement board.

16. The cart in accordance with claim 15, wherein the drawer unit further includes a reinforcing piece located between the bent edges of the support plates and secured to the respective placement board to reinforce the structural strength between the support plates and the respective placement board.

17. The cart in accordance with claim 2, further comprising a plurality of castors mounted on a lowermost one of the placement boards, wherein each of the castors is mounted on the insert of the lowermost one of the placement boards.

18. The cart in accordance with claim 2, wherein the insertion hole of each of the connecting posts extends axially through a whole length of each of the connecting posts.

19. The cart in accordance with claim 2, wherein the insert of each of the placement boards has a tubular shape and extends upward and downward from each of the placement boards.

20. The cart in accordance with claim 1, wherein
each of the connecting posts has a tubular shape;
each of the side plates is a sheet plate.
